(19) United States
(12) Patent Application Publication
(10) Pub. No.: US 2016/0067583 A1
(43) Pub. Date: Mar. 10, 2016

(54) PUTTING TRAINER DEVICE

(71) Applicants: Frederick J. LIGROW, Pinckney, MI (US); Joseph M. MIKLA, (US)

(72) Inventors: Frederick J. Ligrow, Pinckney, MI (US); Joseph M. Mikla, Canton, MI (US)

(21) Appl. No.: 14/784,588

(22) PCT Filed: Apr. 12, 2014
(86) PCT No.: PCT/US2014/033889

§ 371 Date: Oct. 15, 2015

Related U.S. Application Data
(63) Continuation of application No. 13/862,630, filed on Apr. 15, 2013, now abandoned.

(51) Int. Cl. A63B 69/36; G09B 19/00

(52) U.S. Cl. CPC A63B 69/3676; G09B 19/0038; A63B 2225/09; A63B 2071/0694

(57) ABSTRACT

A putting training device includes a base having a first end portion, a second end portion and a middle portion for supporting an inclined, interchangeable elongate putting path member having a variety of widths and lengths for use by a user for improving the users putting stroke.

### BACKGROUND

The present disclosure relates to an exemplary embodiment of a putting training device. More particularly, the present disclosure relates to a particular putting training device which more immediately provides an individual user with more practical and actual feedback of the performance of the putting swing.

It is generally known to provide a putting training device to improve an individual's putting stroke and thereby the individuals putting performance. Generally known examples include the devices and methods disclosed in U.S. Pat. Nos. 4,919,433; 4,634,131; 5,069,455; 5,282,627; 6,129,639; 8,052,540; 6,702,690; 7,431,661; 7,074,134; 7,309,290; US Patent Application Publication Nos. 2011/0300962; and US Design Patent No. D470906.

However, despite such known putting trainer devices, there long remains a significant need for a device which is more realistic, practical and effective at teaching a user a an actual putting stroke. In particular, the generally known putting trainer devices have not been sufficiently successful to materially limit the need for a new putting trainer devices as demonstrated by the prior art. Accordingly, their long remains a significant need to develop an improved putting training device having improved training performance and a more realistic putting in an efficient and effective design.

### SUMMARY OF THE INVENTION

The present disclosure relates to an exemplary embodiment of a putting training device capable of immediately providing an individual user with practical and actual feedback of the performance of the putting swing based upon whether the golf ball rolls up an inclined, elongate putting path member having a first portion supported by a first base portion and a second portion supported by a second base portion, the elongate putting path member having a width approximately the same as the diameter of a golf ball and having a sufficient length to determine the accuracy of the putting stroke typically a length of approximately three feet. The putting training device may include a cup in a base portion and a return mechanism for causing the golf ball to return toward the user. In one exemplary embodiment the putting training device may further include a third or middle base portion located between the first and second base portions for supporting the elongate putting path member at a third portion between the first and second portions of the elongate putting path member. The third base portion may have an end located proximal the second end of the base and the end of the third base portion may include an angle aligned oblique with respect to a longitudinal axis of the elongate putting path member for assisting in returning golf balls to the user. The putting training device may further include interchangeable elongate putting path members having a variety of widths and lengths for customizing the training of the putting stroke by the user.

### DRAWINGS

FIG. 1 is a perspective graphic view of a putting training device according to an exemplary embodiment of the present disclosure;

FIG. 2 is an side plan graphic view of the exemplary embodiment of FIG. 1;

FIG. 3 is an end plan graphic view of the exemplary embodiment of FIG. 1;

FIG. 4 is a top plan graphic view of the exemplary embodiment of FIG. 1;

FIG. 5 is a partial, side plan graphic view taken along the line A-A of the exemplary embodiment of FIG. 4;

FIG. 6 is a partial, plan graphic view taken at the detail section A of the exemplary embodiment of FIG. 5;

FIG. 7 is a partial, plan graphic view taken at the detail section B of the exemplary embodiment of FIG. 5;

FIG. 8 is an exploded perspective graphic view of the exemplary embodiment of FIG. 1;

FIG. 9 is a perspective graphic view of the putting training device according to an exemplary embodiment of the present disclosure;

FIG. 10 is a side, perspective graphic view of the putting training device of FIG. 9 according to an exemplary embodiment the present disclosure;

FIG. 11 is a top, plan graphic view of the putting training device of FIG. 9 according to an exemplary embodiment the present disclosure; and

FIG. 12 is a side, plan graphic view of the putting training device of FIG. 9 according to an exemplary embodiment the present disclosure

### DETAILED DESCRIPTION

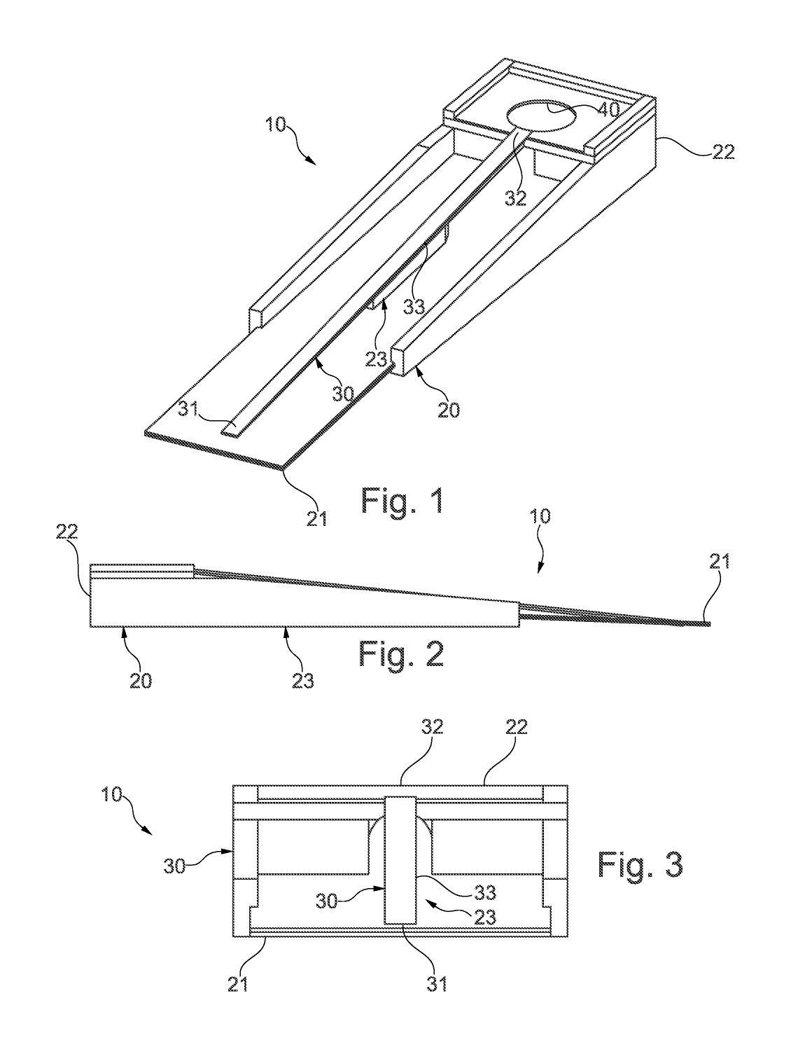

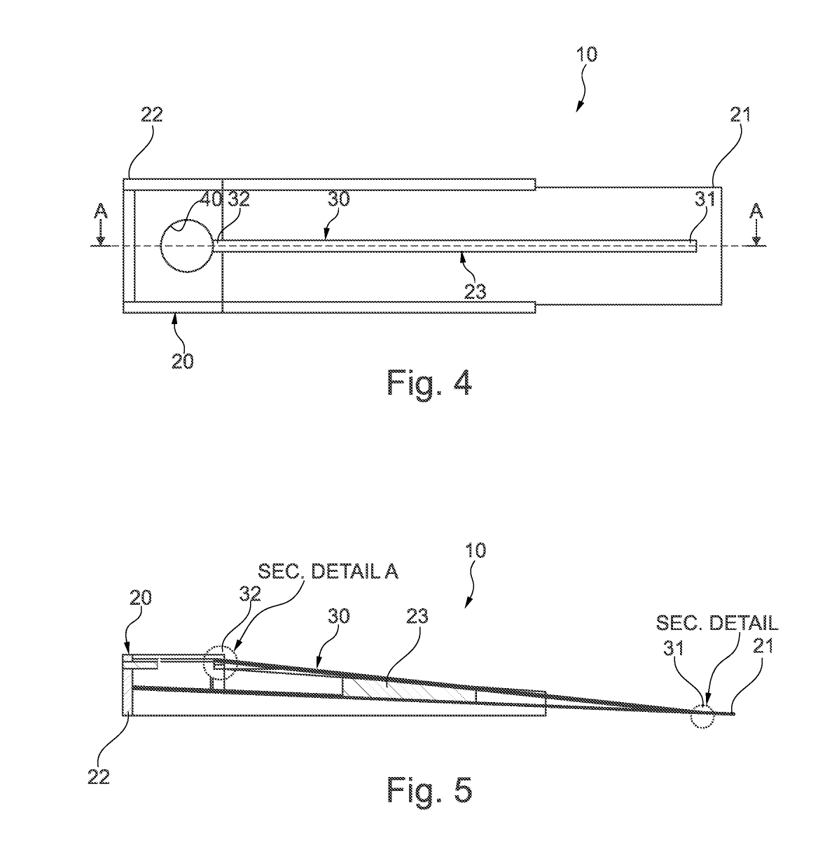

Referring in general to all of the Figures and in particular to FIGS. 1 through 8, an exemplary embodiment of a putting training device 10 according to the present disclosure and teachings is shown. Under the rules of golf, according to the United States golf Association, a golf ball may weigh no more than 1.620 ounces (45.93 grams). Under the same rules, a golf ball may have a diameter not less than 1.680 inches (42.67 mm) Golf balls are subject to testing and approval by the Royal and Ancient Golf Club of St. Andrews and the United States Golf Association, and golf balls that do not conform to the required regulations may not be used in competition. Additionally, regulation golf balls must perform within specified velocity, distance, and symmetry limits In particular, a golf ball must not be designed, manufactured or intentionally modified to have properties which differ from those of a spherically symmetrical ball according to Rule 5 of the Rules of Golf of the United States Golf Association and the specifications of Appendix III thereof.

Typically, the known putting training devices commonly utilize structures and devices for limiting the movement of the golfer's club during the putting swing in an attempt to provide an improved putting result. However, these known putting training devices teach the golfer bad putting habits and strokes and cause the golfer to memorize them. In an exemplary embodiment of the present disclosure, there is provided a putting training device 10 that allows a user to improve the putting result that can be readily transferred to actual game play on the golf course. More particularly, the putting training device 10 according to the present disclosure. In one exemplary embodiment, the putting training device 10 may be particularly useful for improving a user's putting result without the use of any markings on the putting training device 10. The putting training device 10 according to the present disclosure is designed to help a golfer hit straighter putts on a more consistent basis through continuous feedback on the putting stroke and golf ball path up an elevated ramp which more readily physically communicates to the golfer the actual putting result of the putting swing.

The putting training device 10 may include a base or frame 20 having any generally known or appropriate construction. In particular, the base or frame 20 includes a first or end portion 21 and a second or end portion 22 and a third or middle portion 23 as best shown in FIGS. 1 through 5. The putting training device 10 may further include an elongate putting path member or ramp 30 having a first portion or end 31 supported proximal the first base portion 21 and a second end or portion 32 supported proximal the second base portion 22. The elongate putting path member 30 may preferably further have a third or middle portion 33 proximal and supported by the third portion 23 of the base 20.

While the putting training device 10 may be of any generally known or appropriate construction or type, it is most desirable that the putting training device 10 use a construction that will provide that the surface of the ramp 30 will be as level as reasonably possible. As may be appreciated after considering the present disclosure, the surface of the ramp 30 will play a key role in determining the quality of the result of the putting attempt. Accordingly, the surface of the ramp 30 is preferably designed and manufactured to be as nearly perfectly flat as possible and the ramp 30 is preferably supported by the base 20 in a position that is as perfectly level as is reasonably possible. Accordingly, the putting training device 10 of the exemplary embodiment may be designed to be used on a level ground. It should be understood that the levelness of the ramp 30 will necessarily depend upon how level is the base 20 which will necessarily depend upon how level is the ground upon which the cutting training device 10 is placed.

The elongate putting path member 30 may preferably have a width approximately comparable to the diameter of a regulation golf ball. More particularly, the ramp 30 may preferably have a width less than the diameter of the golf ball. Even more particularly, the ramp 30 may preferably have a width of approximately one inch (1″). Even more particularly, the ramp 30 may preferably have a width of approximately one-half inch (½″). In the exemplary embodiment of the putting training device 10 according to the present disclosure, the ramp 30 is disclosed as having a constant width. It should be appreciated that it is possible to have a ramp 30 having a varying width while still achieving the improved putting stroke objectives of the present disclosure.

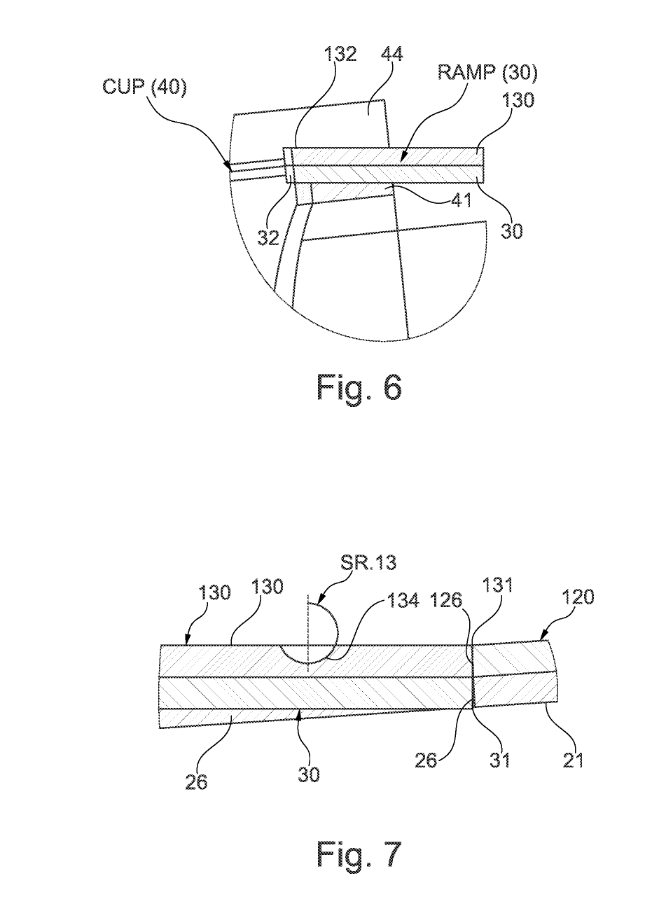

Referring in particular to FIG. 6, there is shown a detail view taken from the detail section noted in FIG. 5, showing that the end 32 of the ramp 30 may be supported by the end 22 of the base 20 such that the ramp 30 may be approximately level with the upper edge of the cup or hole 40 to provide as realistic putting experience as may be reasonably possible.

Referring now in particular to FIG. 7, there is shown a detailed view taken from the detail section proximal end 22 noted in FIG. 5, showing the end 31 of the ramp 30 as received in the end 21 of the base 20. The ramp 30 includes a cover member 130 that may be preferably made from a natural or faux putting surface material, such as carpet or Astroturf. The base 20 includes a hole or passage 26 for receiving the end 31 of the ramp 30. The cover member 130 of the ramp 30 may be aligned evenly with a cover member 120 of the base 20. The cover member 130 may include a depression or dimple 134 proximal the end 131. The dimple 134 may be used for receiving the golf ball in a start position and may prevent the golf ball from moving due to the angular position of the ramp 130.

The ramp 30 may be supported by the base 20 so that the ramp 30 may have an angle from horizontal of approximately between 10° and 30°. More particularly, the ramp 30 may be supported by the base 20 so the ramp 30 may have an angle from horizontal of approximately between 15° and 25°. Even more particularly, the ramp 30 may be supported by the base 20 so the ramp 30 may have an angle from horizontal of approximately 20°. Notwithstanding, it is contemplated that the ramp 30 may be aligned horizontally on the base 20. Further, it is contemplated that the ramp 30 may be aligned at any angle with respect to horizontal. As used here in, horizontal is intended to refer to a line being perpendicular to the direction of gravity. Alternatively, it is contemplated that horizontal may also be intended to refer to the direction of the base 20 of the putting training device 10 according to the exemplary embodiments of the current disclosure.

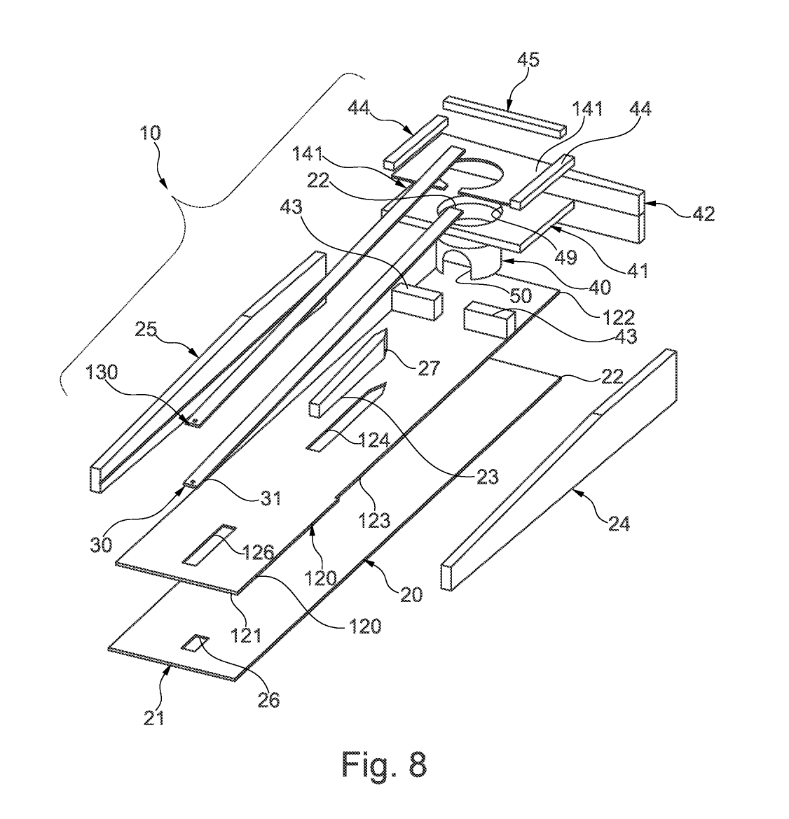

Referring now in particular to FIG. 8, the putting training device 10 according to an exemplary embodiment of the present disclosure is shown in an exploded perspective view. In the present exemplary embodiment, the putting training device 10 includes a base structure similar to the embodiment FIGS. 1 through 5, and includes coverings similar to those shown in FIGS. 6 and 7. Accordingly, it should be understood that the putting training device 10 according to the present exemplary embodiment may alternatively include coverings.

The device 10 includes a base 20 having a first end 21 and a second end 22. The base 20 is supported in a side member 24 and a side member 25. As the putting training device 10 of FIG. 8 may be preferably, but is not necessarily, made from a wood material, the present description is reflective of woodworking techniques used for manufacturing the device 10. The side members 24 and 25 each have a groove formed or cut there in for receiving the sides of the base 20. The grooves in the side members 24 and 25 are preferably cut in the side members so that the base 20 is angled downward toward the end 21 which may be particularly useful in causing the golf ball to be returned to a user using the device 10. The device 10 further includes the covering 120 which may substantially cover the entire upper surface of the base member 20. The base member 20 includes a passage or hole 26 having a substantially rectangular shape located proximal the end 21. The hole 26 is preferably sized and shaped to receive the end 31 of the ramp 30 such that the ramp 30 may be substantially flush or aligned with the base 20. The base 20 may preferably further include a middle portion 23 for supporting the middle portion 33 of the ramp 30. The middle portion 23 may preferably be connected to the base member 20 and located in a hole 124 of the covering member 120. The covering member 120 may preferably further include a passage or hole 126 having a substantially rectangular shape for receiving the end 31 of the ramp 30 along with the end 131 of a covering member 130. The middle member or portion 23 may include an upper end 27 having a pair of angled sidewalls.

As should now be understood, the ramp 30 may include a covering member 130 substantially covering the entire upper surface of the ramp 30. Similar to the covering member 120, the covering member 130 is preferably made from any appropriate or known material such as a carpet or Astroturf type material.

The base 20 may preferably include the second end or support portion 22 for housing the cup or hole 40. The second end 22 of the base 20 includes a platform 41 having a substantially rectangular shape disposed substantially horizontally including a hole 49 aligned with the cup 40. The cup or hole 40 is a substantially cylindrically shaped member for receiving the golf ball through its top or upper end portion and allowing the golf ball to pass through a passage 50 in the side wall of the cylinder of the cup 40. The cup 40 is located proximal the end 22 of the base 20. Since the base 20 is angled with respect to horizontal, a golf ball which passes into the hole 40 will land on the upper surface of the base 20 and gravity will cause the golf ball to exit the cup through the hole 50. Once the golf ball exits the cup 40 through the hole 50, it continues to roll down the base member 20 toward the end 21. Since the top or upper end 27 of the middle member or portion 23 may include a pair of angled sidewalls, the golf ball will be deflected past the middle portion 23 and to one of the sides of the middle portion 23 and back to the user so the ball may be used again with the putting training device 10 without the user having to move from the putting position.

The device 10 according to the present exemplary embodiment may further include a pair of wall members 43 supported on the covering member 120 on the base 24 closing out the area around the hole 40 and located underneath the platform 41. Each wall member 4030 may extend downwardly from the platform 41 to the covering member 120 and may extend from a respective side wall 24 and 25 approximately even with the sides of the hole 50 in the cup 40. The wall members 43 may be made of any known or appropriate material and may have any known or appropriate shape which may function to close out the area under the platform 41.

The platform 41 includes a covering member 141 which is preferably made from the same material as the covering member 120 and the covering member 130. The end 22 of the base 20 may preferably further include side members 44, each side member 44 may extend along the sides of the platform 41 proximal the side members 24 and 25, as well as and end side member 45 extending between the side members 44. The side members 44 and the end member 45 may extend upwardly from the covering member 141 and function to limit or prevent a golf ball from rolling off of the platform 41 of the putting training device 10. The device 10 may further include an end member 42 that may include a groove cut therein for receiving and supporting the end 22 of the base member 20. In one particularly exemplary embodiment, all, or any portion thereof, of the components the base 20 may be preferably constructed from a wood or wood composite material but may alternatively be made from a plastic, steel or any other known or appropriate material including in any combination. Accordingly, the components of the base 20 may be coupled or connected together using any known or appropriate device for coupling including fasteners, adhesives, or any other known or appropriate device or material for appropriately keeping the components of the base 20 together.

The putting training device 10 according to the exemplary embodiment of the present disclosure is particularly designed to provide a more realistic, actual golf ball putting stroke and training experience including nearly immediate feedback regarding the actual putting stroke results. If the golf ball travels the entire length of the ramp 30 (i.e., 36 inches in one exemplary embodiment) and into the golf cup or hole 40, then the putting stroke was successful and the golfer is immediately so advised.

If the golf ball does not travel the entire length of the ramp 30 and into the hole 40, then the putting stroke was unsuccessful and the golfer is also immediately so advised. Further, if the putting attempt was unsuccessful, then the ball fell off the ramp 30 either to the left or the right before reaching the end 32 of the ramp 30, then the user is immediately advised and understands how the club face of the putter was improperly aligned. The golfer is immediately advised, based upon whether the ball fell off the ramp 30 to the right side or to the left side, whether the putting stroke had the face of the putter too open or too closed, depending upon whether the putter is right-handed or left-handed).

The perfect or ideal putting stroke will have the face of the putter forming a ninety degree)(90°) or right angle with the intended line of the putt when striking the golf ball. In practice using the putting training device 10, this is the putting ramp 30. The perfect or ideal putting stroke will also strike the golf ball with an appropriate amount of force to cause the ball to travel the desired distance. In practice using the putting training device 10, this is learned by the user by putting the golf ball up the ramp 30 to the end 32 of the ramp and into the cup or hole 40. If the face of the putter is closed (creating an acute angle of less than 90°) the resulting putt will “pull” the ball to the same side as the golfer and the ball will fall off the side of the ramp 30 before it makes it to the end 32 of the ramp 30. If the face of the putter is open (creating an obtuse angle of greater than 90°) the resulting putt will be a “push” and the ball will fall off the side of the ramp 30 before making it to the end 32. As should be appreciated from the above, the length and width of the ramp 30 will play an important factor in determining how much of an angle from 90° will still be successful in placing the ball in the hole 40.

The width of the ramp 30 in relation to the diameter of a golf ball is particularly useful to teach the golfer/user the objectives and measurements of putting without the necessity for any additional markings or structures. The width of the ramp 30 plays an important factor in the analysis of the success of the putting training device 10 and the improvement of the user's putting stroke and performance. For example, a ramp 30 having a one inch (1″) width will have more room for error than a ramp having a width of one half inch (½″) which will require the golfer to have far greater precision to be successful.

The objective for each putting stroke by the golfer is to make a quality, square contact with the golf ball that sends the golf ball up the ramp 30, in a straight line and into the golf hole or cup 40. In one particularly exemplary embodiment, the ramp 30 may preferably have a length of at least twelve (12) inches. In one alternative exemplary embodiment, the ramp 30 may preferably have a length of at least twenty-four (24) inches. In one alternative exemplary embodiment, the ramp 30 may preferably have a length of thirty-six (36) inches. Alternatively, the distance may be measured from the starting point to the cup or hole 40. Regardless, any putting stroke by the golfer that does not make appropriately square contact with the golf ball and have appropriate speed will not make the golf ball follow the straight line of the ramp 30 and it will fall off the ramp 30 to either the left or right side depending on how the face of the putter was misaligned to the golf ball at impact.

In one particular exemplary embodiment of the present disclosure, it is contemplated that the putting training device 10 will have a plurality of interchangeable ramps 30, each having a different width. By having different width ramps 30, it is possible for a user to begin using the putting training device 10 using a ramp having a greater width, for example, a width of approximately 1½ inches (or greater). Once the user improves her putting stroke and performance using the ramp 30 having a width of 1½ inches, the ramp 30 may be replaced with a more narrow ramp 30 having a width of approximately 1 inch. With the more narrow 1 inch ramp 30 in place, the user is again challenged to improve her putting stroke and performance by continuing to practice on the putting training device 10. Again, once the user improvers her putting stroke and performance using the ramp 30 having a width of 1 inch, that ramp 30 may be replaced with an even more narrow ramp 30 having a width of approximately ¾ inch (or less). It is also possible to include adjustable the base portions of the base 20 and to have interchangeable ramps 30 having different lengths as explained herein to provide even greater adjustability and putting stroke learning opportunities for a user.

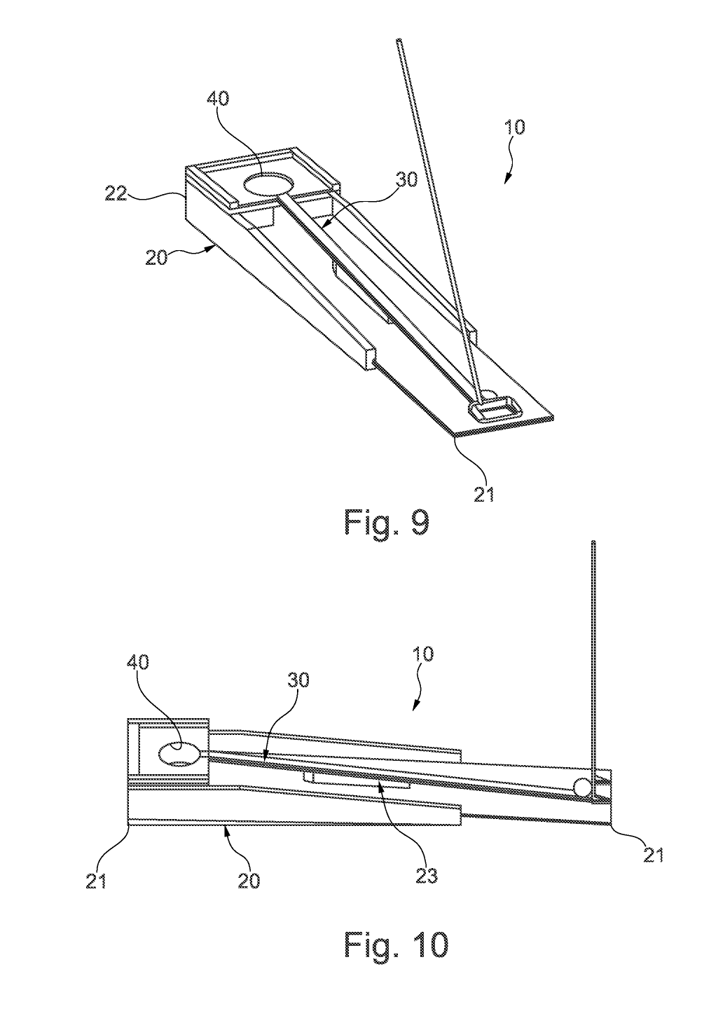

Based upon experience, the highest probability of putting failure is that the ball will fall off the ramp 30 to either the left or right sides before reaching the hole as best shown in FIGS. 9 through 12. Significantly, there are other failure modes that the putting training device 10 according to the present disclosure will identify for the user. In particular, the putting training device 10 will also identify lower probability modes of failure wherein the golfer uses a putting stroke that strikes golf ball with enough force to jump or hop over the hole 40 wherein the golf ball ends up lying on the platform 41 of the end 22 (or worse, the golf ball entirely leaves the putting training device 10). This scenario is also considered a failure and is also immediately identified to the golfer who will know that the putting stroke needs to be appropriate adjusted to correct the speed of the putting stroke but not how square the face of the putter is with respect to the golf ball.

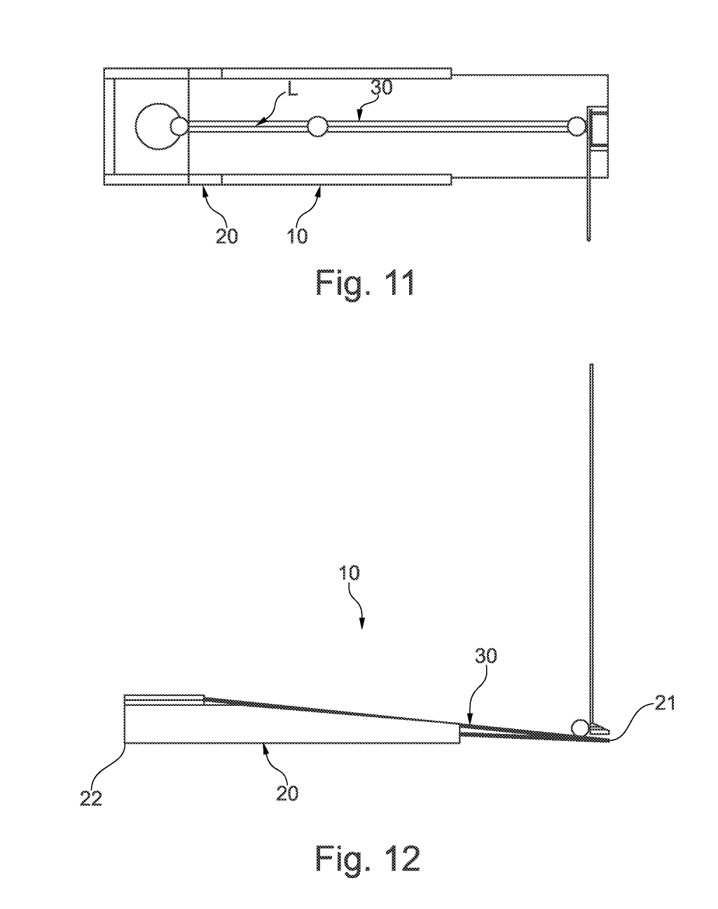

In one alternative exemplary embodiment, the putting training device 10 may include a thin, contrast or colored, centrally located line L running the length the ramp 30 to provide an additional visual indicator of accuracy as best shown in FIG. 11.

Any numerical values recited herein or in the figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one Unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “‘x’ in percent by weight of the resulting polymeric blend composition.”

Unless expressly stated, all ranges are intended to include both endpoints and all numbers between the endpoints, The use of “about” or “approximately” in connection with a range applies to both ends of the range, Thus, “about 20 to 30” is intended to cover “about 20 to about 30”, inclusive of at least the specified endpoints.

The use of the term “consisting essentially or to describe a combination shall include the elements, ingredients, components or steps identified, and such other elements ingredients, components or steps that do not materially affect the basic and novel characteristics of the combination. The use of the terms “comprising”” or “including” to describe combinations of elements, ingredients, components or steps herein also contemplates embodiments that consist essentially of the elements, ingredients, components or steps. By use of the term “may” herein, it is intended that any described attributes that “may” be included are optional.

The disclosure of “a” or “one” to describe an element, ingredient, component or step is not intended to foreclose additional elements, ingredients, components or steps. Plural elements, ingredients, components or steps can be provided by a single integrated element, ingredient, component or step. Alternatively, a single integrated element, ingredient, component or step might he divided into separate plural elements, ingredients, components or steps.

It is understood that the present description is intended to be illustrative and not restrictive. Many embodiments as well as many applications besides the examples provided will he apparent to those of skill in the art upon understanding the present disclosure. The scope of the claimed invention should, therefore, not he determined with limiting reference to the description, but should instead be determined with reference to the appended claims, along with the full scope of equivalents to which such claims are entitled, Any disclosure of an article or reference, including patent applications and publications, is incorporated by reference herein for all purposes. Any omission in the following claims of any aspect of subject matter disclosed herein is not a disclaimer of such subject matter.

We claim:

1. A putting training device, comprising:
a. a first base portion;
b. a second base portion located distal from the first base portion; and
c. an inclined, elongate putting path member having a first portion supported by the first base portion and a second portion supported by the second base portion, the elongate putting path member extending between and inclined between the first and second base portions and having a width approximately the same as the diameter of a golf ball.

2. The putting training device of claim 1 further comprising a third base portion located between the first and second base portions, the third base portion supporting the elongate putting path member at a third portion between the first and second portions of the elongate putting path member.

3. The putting training device of claim 2 wherein the third base portion has an end located proximal the second base portion, the end of the third base portion having an angle aligned oblique with respect to a longitudinal axis of the elongate putting path member.

4. The putting training device of claim 1 wherein the elongate putting path member is interchangeable.

5. The putting training device of claim 4 wherein the interchangeable elongate putting path member has a width of greater than one inch.

6. The putting training device of claim 4 wherein the interchangeable elongate putting path member has a width of approximately one inch.

7. The putting training device of claim 4 wherein the interchangeable elongate putting path member has a width of less than one inch.

8. The putting training device of claim 4 wherein the interchangeable elongate putting path member has a width of approximately ¾ inch.

9. The putting training device of claim 4 wherein the interchangeable elongate putting path member has a length of greater than one foot.

10. The putting training device of claim 4 wherein the elongate putting path member has a length of greater than two feet.

11. The putting training device of claim 4 wherein the elongate putting path member has a length of approximately three feet.

12. A putting training device, comprising:
a. a first base portion;
b. a second base portion located distal from the first base portion;
c. a third base portion located between the first and second base portions, the third base portion supporting the elongate putting path member at a third portion between the first and second portions of the elongate putting path member, the third base portion having an end located proximal the second base portion, the end of the third base portion having an angle aligned oblique with respect to a longitudinal axis of the elongate putting path member; and d. an inclined, elongate putting path member having a first portion supported by the first base portion and a second portion supported by the second base portion, the elongate putting path member having a width approximately the same as the diameter of a golf ball.

13. The putting training device of claim 12 wherein the elongate putting path member is interchangeable for providing a variety of elongate putting path members having varying widths and lengths.

14. The putting training device of claim 12 wherein the interchangeable elongate putting path member has a width of approximately ¾ inch.

15. The putting training device of claim 12 wherein the elongate putting path member has a length of approximately three feet.
